(19) United States
(12) Patent Application Publication
(10) Pub. No.: US 2017/0002767 A1
(43) Pub. Date: Jan. 5, 2017

(54) REGENERATOR FOR A THERMAL CYCLE ENGINE

(71) Applicant: NV BEKAERT SA, Zwevegem (BE)

(72) Inventor: Frank VERSCHAEVE, Otegem (BE)

(73) Assignee: NV BEKAERT SA, Zwevegem (BE)

(21) Appl. No.: 15/114,318

(22) PCT Filed: Mar. 4, 2015
(86) PCT No.: PCT/EP2015/054497

§ 371 Date: Jul. 26, 2016

(30) Foreign Application Priority Data
Mar. 12, 2014 (EP) 14159007.5

(51) Int. Cl. F02G 1/057; B23P 15/26; F28D 17/02

(52) U.S. Cl. CPC F02G 1/057; F28D 17/02; B23P 15/26

(57) ABSTRACT

The regenerator has a central axis. The regenerator has a multitude of web layers wound around the central axis. The web layers are formed by two or more metal fiber or metal wire having webs wound around the central axis. When observed from the central axis to the outside of the regenerator, at least one web layer of a web of a first width is followed by a web layer of a web of a width larger than the web of a first width.

### TECHNICAL FIELD

The invention relates to a regenerator for a thermal cycle engine, e.g. a stirling engine, and to a method for manufacturing such a regenerator.

### BACKGROUND ART

A regenerator is used in a thermal cycle engine to add or remove heat from the working fluid during the different phases of the thermal cycle. Regenerators are important parts for defining the efficiency of thermal cycle engines (e.g. stirling engines).

A regenerator needs to have a very low thermal conductivity in the fluid flow direction—which is along the axis of the regenerator—, since one end of the regenerator is hot and the other end is cold. The regenerator needs to have very high thermal conductivity in the direction normal to the fluid flow so that the working fluid can rapidly adjust itself to the local temperature inside the regenerator. The regenerator must have a very large specific surface area to improve the rate of heat transfer of the working fluid. The regenerator must have a low loss flow path for the working fluid, so that minimal pressure drop will result when the working fluid moves through the regenerator. If the regenerator is made of fibers, the regenerator must be fabricated in such a manner as to prohibit fiber migration as fiber fragments might be entrained in the working fluid and transported to the compression or expansion cylinders resulting in damage to the piston seals.

Different types of regenerators have already been described. Typically, such regenerators comprise metal screens, cylindrically wound wire gauze or 3D random fiber networks as e.g. described in JP1240760, JP2091463 and WO01/65099; or even short metal fibers as e.g. described in EP 1341630.

WO2010/108778 discloses a regenerator for a thermal cycle engine comprising a network of metal fibers. The metal fibers have an average fiber length ranging from 0.6 cm to 6 cm. A majority of the metal fibers are randomly spread in a tangential plane encircling the axis of the thermal cycle engine. The regenerator can be made via coiling a fiber web around an axis.

WO2010/108778 further discloses a method to make such a regenerator. A fiber web is provided that has at least a leading edge. The fiber web is cylindrically wound, parallel to the leading edge, around a reel having a diameter almost equal to the internal diameter of the regenerator, until the predetermined diameter, being the outer of the regenerator, is obtained. A mesh is provided that has at least a mesh leading edge. The mesh is cylindrically wound around the wound fiber web, parallel to the leading edge. The wound web is sintered in such a manner as to crosslink the fibers at points of close contact between the fibers. The mesh is removed from around the sintered regenerator.

WO2007/148082 describes a regenerator comprising a foil portion adjacent to the hot space of a stirling engine and a wire portion adjacent to the cool space of the stirling engine. Regeneration at the hot space end is performed by the foil portion and regeneration at the cool space end is performed by the wire portion. It is a benefit that this regenerator suits the thermal conditions at both ends of the regenerator.

DE29520864U1 discloses a regenerator comprising layers of fiber webs (e.g. needled felt) of ceramic or glass fibers perpendicularly to the fluid flow direction. The layers can have different material properties or different porosity.

It is a problem of the prior art that no highly efficient regenerator is available with varying properties in the fluid flow direction and that can be manufactured in a cost effective way.

### DISCLOSURE OF INVENTION

The primary objective of the invention is to provide a regenerator for a thermal cycle engine with improved properties.

It is another objective of the invention to provide a method to manufacture such an improved regenerator.

The first aspect of the invention is a regenerator for a thermal cycle engine. The regenerator has a central axis. Preferably the central axis is a central axis of symmetry. The central axis can be a virtual axis. The regenerator comprises a multitude of web layers wound around the central axis. The web layers are formed by two or more metal fiber or metal wire comprising webs wound around the axis. When observed from the central axis to the outside of the regenerator, at least one web layer of a web of a first width is followed by a web layer of a web of a width larger than the web of a first width.

It is a benefit of the invention that a regenerator can be provided in a cost effective way that has over its axial length varying properties, e.g. in porosity and/or in open surface area of the cross section. With open surface area of the cross section is meant the surface area of the voids in the cross section through which working fluid will flow when the regenerator is in use. It is beneficial to have at the hot side of the regenerator more space available for the fluid to flow through the regenerator than at the cool side. This can be achieved by providing a larger porosity at the hot side and/or by providing a larger cross sectional area of the regenerator for working fluid to flow at the hot side. Such regenerators could be thought of as comprising layers of web, wherein the width of the web used for winding the web layers decreases from the inside to the outside of the regenerator. However, experiments have shown that in this way it is not possible to keep the web position under control, meaning that no decent regenerator could be made. This problem is solved by the method of the second aspect of the invention. The use of the method of the second aspect of the invention results in the regenerator as described in the first aspect of the invention.

The webs can e.g. be nonwoven webs comprising metal fibers, preferably stainless steel fibers. The webs can e.g. be or comprise knitted metal wire mesh or woven metal wire mesh, preferably using stainless steel wires. Preferred nonwoven webs for use in the invention comprise metal fibers, preferably stainless steel fibers, with an equivalent diameter of between 1.5 and 100 μm, more preferably between 12 and 40 μm. Preferred nonwoven webs comprising metal fibers for use in the invention have a specific weight between 20 and 1000 g/m², more preferably between 75 and 450 g/m².

Preferably, when observed from the central axis to the outside of the regenerator, the width of the web forming the first web layer of the regenerator and the width of the web forming the last web layer of the regenerator are larger than the width of a web forming intermediate web layers in the regenerator. With intermediate web layer is meant a web layer in between, when observed from the central axis to the outside of the regenerator, the first web layer of the regenerator and the last web layer of the regenerator.

Preferably the width of the web forming the first web layer of the regenerator and the width of the web forming the last web layer of the regenerator are the same.

Preferably, a number of web layers are formed by web of a first width wound around the central axis, with in between these web layers, web layers formed by web of a second width larger than the web of a first width wound around the central axis. Preferably webs of the second width are used to form the first web layers of the regenerator, as seen from the central axis. Preferably, the second width is equal to the height of the regenerator.

Preferably, the side ends of web layers of webs of different widths (and preferably of all web layers in the regenerator) are aligned at one end of the regenerator.

In a preferred embodiment, the regenerator has over its axial length a constant cross sectional shape and size. Preferably, such a regenerator has over its axial length different levels of porosity. Preferably the porosity is at one axial end of the regenerator lower than at the other axial end. Preferably the highest and the lowest levels of porosity are located at the axial ends of the regenerator.

In a preferred embodiment, the open surface area of the cross section of the regenerator available for working fluid to flow is lower at one end than at the other end of the regenerator. Preferably, the largest and the smallest open surface area of the cross section of the regenerator available for working fluid to flow are located at the ends of the regenerator.

Preferably, the porosity of the regenerator is substantially constant over the axial length of the regenerator. Preferably, the porosity is higher than 90%, even more preferably higher than 92%. Such porosity can e.g. be obtained by using metal fiber nonwoven webs.

In a preferred embodiment, the regenerator has over its axial length different levels of porosity. Preferably the porosity is at one axial end of the regenerator lower than at the other axial end. Preferably the highest and the lowest levels of porosity are located at the axial ends of the regenerator. Preferably, the highest level of porosity is more than 90%, more preferably more than 92%.

In a preferred embodiment, the regenerator does not comprise metallic bonds between the metal fibers or metal wires of the webs. Preferably, such a regenerator has at least a section with porosity of more than 92%. When such a regenerator has a constant porosity, the constant porosity is preferably more than 92%.

In a preferred embodiment, the regenerator comprises metallic bonds between the metal fibers or metal wires of the different webs in the regenerator. Examples are sintered bonds or welded bonds or brazed bonds. Welded bonds can e.g. be formed by means of capacitor discharge welding (CDW). Preferably, such a regenerator has at least a section with porosity of more than 90%. When such a regenerator has a constant porosity, the constant porosity is preferably more than 90%.

Preferably, the metal fibers in the metal fiber comprising webs have an average length of at least 12 mm, more preferably of at least 15 mm. It is a benefit of this embodiment that the webs comprising such metal fibers, e.g. stainless steel fibers, can be easily manipulated to manufacture the regenerator.

In a preferred embodiment, the regenerator is a regenerator ring or a regenerator disc. In a preferred regenerator ring, the area encircled by the cross section of the regenerator ring is constant over the height of the regenerator ring.

Even if the metal fibers are bonded in the regenerator by means of metallic bonds, it is possible to analyse the construction and web layer built-up of the regenerator by making cross sections of the regenerator.

A second aspect of the invention is a method to manufacture a regenerator for a thermal cycle engine as in the first aspect of the invention. The method comprises the steps of
providing two or more webs comprising metal fibers or metal wires. Webs of a number of different widths are provided. The webs of different width can have the same structural and physical parameters except for their width.
winding the webs around a shaft or a core, thereby building up web layers of the web or webs being wound;
wherein after forming a web layer by winding a web of a first width, a web layer is formed from a web of a width larger than the web of a first width; and
optionally removing the shaft or the core.

Preferably the webs are aligned at one side of the webs for winding the webs around the shaft or the core. More preferably all webs are aligned at one side of the webs for winding the webs around the shaft or the core.

It is a benefit of the method of the invention that regenerators, e.g. regenerator rings, can be made of different cross sectional dimensions and/or porosity over the direction of flow of the fluid through the regenerator. The method allows setting specific levels of porosity over the fluid flow direction of the regenerator. The method allows setting the open cross sectional area available for fluid flow over the length of the regenerator.

In a preferred method, webs of different width are put on top of each other in order to wind them together around the shaft or the core.

In a preferred method, webs of different widths are unwound from rolls and wound together around the shaft or the core.

In a preferred method the width of the web first wound and the width of the web last wound are larger than the width of at least one web wound in between. Preferably the width of the web wound last has the same width as the web wound first.

Preferably, a number of web layers are formed by winding web of a first width around the core or shaft, with in between these web layers, web layers formed by web of a second width larger than the web of a first width wound around the central axis. Preferably webs of the second width are used to form the first web layer or first web layers of the regenerator, as seen from the central axis. Preferably, the second width is equal to the height of the regenerator.

A preferred method comprises the additional step of bringing the regenerator to shape. The bringing into shape can e.g. be performed by pressing in a mould. The bringing to shape can e.g. be setting the cross sectional area, e.g. to set a cylindrical or annular shape with substantially constant cross section over the axial length of the regenerator; or to a shape wherein the cross sectional area varies over the axial length of the cylindrical or annular regenerator.

In a further step, metallic bonds, e.g. by means of sintering, can be created between the metal fibers or metal wires of the different webs in the regenerator.

A third aspect of the invention is a thermal cycle engine comprising a regenerator as in the first aspect of the invention, wherein the cross section of the regenerator has at its hot side a larger open surface area between the metal fibers or metal wires for fluid to flow than at its cold side.

### BRIEF DESCRIPTION OF FIGURES IN THE DRAWINGS

FIG. 1 shows a regenerator ring according to the invention.

FIG. 2 shows another regenerator ring according to the invention.

FIG. 3 shows the layer built up of the regenerator rings of FIGS. 1 and 2.

### MODE(S) FOR CARRYING OUT THE INVENTION

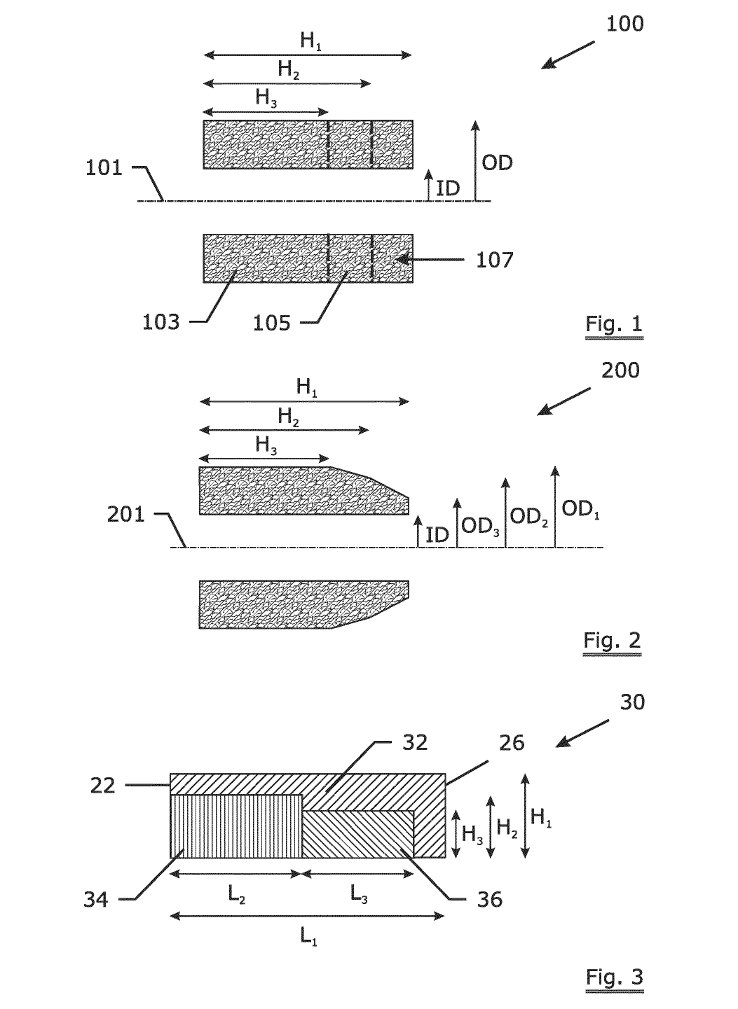

FIG. 1 shows an example 100 of a regenerator ring according to the invention. The regenerator has a central axis of symmetry 101. The regenerator has over its axial length H₁ a constant cross sectional shape and size. The regenerator ring has an axial length H₁, e.g. 72 mm. The inner diameter is ID, e.g. 143 mm and the outer diameter is OD, e.g. 221 mm. The regenerator ring has three sections with different porosity levels, a first section 103 with a length H₃, e.g. of 48 mm of a first porosity of e.g. 90%, a second section 105 with a length H₂-H₃ (e.g. 60 mm-48 mm=12 mm) of a higher porosity than the first porosity, e.g. 92.4%; and a third section 107 with a length H₁-H₂ (e.g. 72 mm-60 mm=12 mm) of a still higher porosity, e.g. 94.6%.

FIG. 2 shows another example 200 of a regenerator ring according to the invention. The regenerator has a central axis of symmetry 201. The regenerator has over its axial length H₁, e.g. 72 mm, different cross sectional shapes and sizes. The inner diameter is ID, e.g. 143 mm. Over a first length H₃, e.g. 48 mm, the regenerator has an outer diameter OD₁, e.g. 221 mm. The outer diameter is then reducing. At a length H₂, e.g. 60 mm, the outer diameter is OD₂, e.g. 205 mm. At the other end of the regenerator (at a length H₁ e.g. 72 mm), the outer diameter is OD₃, e.g. 189 mm. The porosity is substantially constant over the regenerator, and is e.g. 90%.

Both the regenerators of FIGS. 1 and 2 have been made using the same metal fiber webs. FIG. 3 shows the arrangement of the web layers of the regenerators of FIGS. 1 and 2 (virtually) unwound from the regenerators. FIG. 3 is also illustrating the way the regenerators can be manufactured. Side 26 shows the side of the web layers when starting unwinding the regenerator from the outer diameters. Side 22 shows the side of the web layers at the inner diameter of the regenerator. The way the regenerator is build-up will be explained by describing the way the regenerator has been made.

The regenerators of FIGS. 1 and 2 can be made in the following way, as illustrated by means of FIG. 3. Three rectangular webs 32, 34 and 36 are provided, wherein two webs 34 and 36 are put on top of web 32 in the way as shown in FIG. 3.

The first web 32 has a length L₁ of 32.22 m and a width H₁ of 72 mm. On top of it, and at the leading edge 22 of the first web 32 and aligned with the first web 32, the second web 34 is put. The length L₂ of the second web 34 is 13.06 m and its width H₂ is 60 mm. At the end of the length of the second web 34, and on top of the first web 32, the third web 36 is put in the way as indicated in FIG. 3. The third web 36 has a length L₃ of 14.31 m and a width H₃ of 48 mm. When putting the webs on top of each other, there is a certain sticking of the fibers of the different webs, creating cohesion that is helpful when winding the webs. Instead of using webs of the length indicated, web panels of shorter length can be positioned one after the other to obtain the required length of web of a specific width. The three webs 32, 34 and 36 are identical in composition and specific weight. For the examples shown in FIGS. 1 and 2, a carded stainless steel fiber web (bundle drawn AISI 316L steel fibers of 30 μm equivalent diameter) of 300 g/m² has been used. For the invention, it is also possible to use for the three webs, webs of different composition and/or of different specific weight. Using webs with different properties can facilitate the setting of properties of the regenerator over its axial length.

The so formed stack of webs 30 is wound around a core of appropriate diameter, starting from the leading edge 22 of the stack of webs. The leading edge 22 is positioned parallel to the core and winding is started. By winding, the web layers of the regenerator ring are formed. Winding stops when the full length of the stack of webs has been wound, ending at edge 26 of the stack of webs 30, which is in this example also the end of the first web 32.

An alternative approach instead of putting web panels on top of each other is unwinding webs from rolls and winding them together onto a core.

The wound web layers can then be pressed into a specific shape to form a regenerator. The web layers can be pressed into a shape with constant inner and outer diameter over the axial length of the regenerator, thereby arriving at the regenerator of FIG. 1, with the exemplary dimensions as provided in the description of the regenerator of FIG. 1.

Alternatively, the web layers can be pressed into a regenerator ring shape that has varying cross section and/or shape over the axial length of the regenerator ring, e.g. the regenerator of FIG. 2, with the exemplary dimensions as provided in the description of the regenerator of FIG. 2.

1-15. (canceled)

16. A regenerator for a thermal cycle engine,
wherein the regenerator has a central axis;
wherein the regenerator comprises a multitude of web layers wound around the central axis;
wherein the web layers are formed by two or more metal fiber or metal wire comprising webs wound around the central axis;
wherein when observed from the central axis to the outside of the regenerator, at least one web layer of a web of a first width is followed by a web layer of a web of a width larger than the web of a first width.

17. The regenerator as in claim 16, wherein when observed from the central axis to the outside of the regenerator, the width of the web forming the first web layer of the regenerator and the width of the web forming the last web layer of the regenerator are larger than the width of a web forming intermediate web layers in the regenerator.

18. The regenerator as in claim 16, wherein a number of web layers are formed by web of a first width wound around the central axis, with in between these web layers, web layers are formed by web of larger width than the web of a first width wound around the central axis.

19. The regenerator as in claim 16, wherein the side ends of web layers of webs of different widths are aligned at one end of the regenerator.

20. The regenerator as in claim 16, wherein the regenerator has over its axial length a constant cross sectional shape and size.

21. The regenerator as in claim 16, wherein the open surface area of the cross section of the regenerator available for working fluid to flow is lower at one end than at the other end of the regenerator.

22. The regenerator as in claim 16, wherein the regenerator has over its axial length different levels of porosity.

23. The regenerator as claim 16, wherein the regenerator does not comprise metallic bonds between the metal fibers or metal wires of the webs.

24. The regenerator as in claim 16, wherein the regenerator comprises metallic bonds between the metal fibers or metal wires of the different webs in the regenerator.

25. The regenerator as in claim 16, wherein the web layers are formed by metal fiber comprising webs and wherein the metal fibers in the metal fiber comprising webs have an average length of at least 12 mm.

26. A method to manufacture a regenerator for a thermal cycle engine as in claim 16, comprising the steps of
providing two or more webs comprising metal fibers or metal wires, wherein webs of a number of different widths are provided;
winding the webs around a shaft or a core, thereby building up web layers of the web or webs being wound;
wherein after forming a web layer by winding a web of a first width, a web layer is formed from a web of a width larger than the web of a first width.

27. The method as in claim 26, wherein the width of the web first wound and the width of the web last wound are larger than the width of at least one web wound in between.

28. The method as in claim 26, wherein a number of web layers are formed by winding webs of a first width, and in between these web layers, web layers are formed by winding webs of larger width than the webs of a first width.

29. The method as in claim 26, comprising the additional step of bringing the regenerator to shape.

30. A thermal cycle engine comprising a regenerator as in claim 16, wherein the cross section of the regenerator has at its hot side a larger area of voids between the metal fibers or metal wires for fluid to flow than at its cold side.
